(19) United States
(12) Patent Application Publication
(10) Pub. No.: US 2026/0325958 A1
(43) Pub. Date: Oct. 22, 2026

(54) INFORMATION PROCESSING SYSTEM, ONE OR MORE NON-TRANSITORY COMPUTER-READABLE STORAGE MEDIUM, AND COMPUTER-IMPLEMENTED METHOD

(71) Applicant: NINTENDO CO., LTD., Kyoto-shi (JP)

(72) Inventor: Toshiaki SUZUKI, Kyoto-shi (JP)

(21) Appl. No.: 19/692,043

(22) Filed: May 29, 2026

Related U.S. Application Data
(63) Continuation of application No. PCT/JP2024/014147, filed on Apr. 5, 2024.

(51) Int. Cl. A63F 13/285; A63F 13/22

(52) U.S. Cl. CPC A63F 13/285; A63F 13/22

(57) ABSTRACT

An information processing system includes: a controller including a vibrator and capable of user operations in a plurality of states including a first state where the controller is operated on a work surface and a second state where the controller is operated away from the work surface; and one or more processors and one or more memories storing instructions that cause the one or more processors to perform operations comprising vibrating the vibrator when a specified condition is satisfied. The vibrating comprises vibrating the vibrator more strongly when an operation state of the controller is the first state than when the operation state is the second state.

### CROSS REFERENCE TO RELATED APPLICATION

This application is a continuation of International Application No. PCT/JP2024/14147, filed on Apr. 5, 2024, the entire contents of which are incorporated herein by reference.

### FIELD

This disclosure relates to information processing for controlling a controller including a vibrator.

### BACKGROUND AND SUMMARY

Conventionally, a controller including a vibrator has been known.

In the above-described technology, there was room for providing appropriate vibration to a user when a novel controller is used.

In view of the above points, for example, the following configuration examples are given.

### Configuration 1

Configuration 1 is an information processing system including: a controller including a vibrator and capable of user operations in a plurality of states including a first state where the controller is operated on a work surface and a second state where the controller is operated away from the work surface; one or more processors; and one or more memories storing instructions that cause the one or more processors to perform operations including vibrating the vibrator when a specified condition is satisfied. The vibrating includes vibrates the vibrator more strongly when an operation state of the controller is the first state than when the operation state is the second state.

There is a possibility that user's perception differs even if vibration of the same intensity is outputted to the controller between a case where the controller is on the work surface (the first state) and a case where the controller is not on the work surface (the second state). In this regard, according to the above configuration example, it is possible to make the perception of vibration when the specified condition is satisfied closer between when the controller is in the first state and when the controller is in the second state.

### Configuration 2

In Configuration 2 based on Configuration 1 above, the vibrating may include, during a period from after starting the vibration when the operation state of the controller is the first state until control related to the vibration ends, keeping intensity of the vibration even if the operation state of the controller changes from the first state to the second state.

### Configuration 3

In Configuration 3 based on Configuration 1 above, the vibrating may include, during a period from after starting the vibration when the operation state of the controller is the second state until control related to the vibration ends, keeping intensity of the vibration even if the operation state of the controller changes from the second state to the first state.

According to the above configuration example, after vibration is once started with a specified intensity, it is possible to reduce the risk of occurrence of a sense of discomfort due to the intensity of vibration changing during the vibration.

### Configuration 4

In Configuration 4 based on any one of Configurations 1 to 3 above, the vibrating may include changing a frequency for vibrating the vibrator depending on whether the controller is in the first state or the second state.

According to the above configuration example, it is possible to vibrate at a frequency corresponding to the state, and it is possible to make the perception of vibration closer between the first state and the second state.

### Configuration 5

In Configuration 5 based on any one of Configurations 1 to 4 above, the operations may further include allowing a user to set at least one of intensity of vibration of the vibrator in the first state and intensity of vibration of the vibrator in the second state.

According to the above configuration example, it is possible to make the perception of vibration closer between the first state and the second state. It is conceivable that there are individual differences among users regarding the degree of pressing the controller against the work surface in the first state and how the controller is held in the second state. Therefore, by allowing the user to set the intensity of vibration in each state by the user himself/herself, the user himself/herself can confirm and set the optimum degree for making the perception of vibration in each state closer. As a result, the perception of vibration between when the controller is in the first state and when the controller is in the second state can be made closer while taking into account the individual differences.

### Configuration 6

In Configuration 6 based on any one of Configurations 1 to 5 above, the operations may further include determining whether the controller is on the work surface. The first state may be a state where the controller is determined to be on the work surface, and the second state may be a state where the controller is determined not to be on the work surface.

According to the above configuration example, it is possible to distinguish between the first state and the second state by determining whether the controller is placed on the work surface. Accordingly, adjustment of the intensity of vibration can be automatically performed according to the state of the controller.

### Configuration 7

In Configuration 7 based on any one of Configurations 1 to 5 above, the controller may further include a physical switch configured to allow a user to perform a switching operation between two states. The first state may be a state when a state of the switch is a third state, and the second state may be a state when the state of the switch is a fourth state.

According to the above configuration example, it is possible to distinguish between the first state and the second state based on the state of the physical switch provided on the controller. In addition, by the user switching the switch, the state of the controller can be explicitly set.

### Configuration 8

In Configuration 8 based on any one of Configurations 1 to 5 above, the first state may be a state where specified processing is executed for a specified operation on the controller, and the second state may be a state where processing different from the specified processing is executed for the specified operation.

According to the above configuration example, for example, it is possible to provide execution of appropriate processing corresponding to the operation state of the controller such as a difference in how the controller is held, etc., and appropriate intensity of vibration corresponding to each state.

### Configuration 9

In Configuration 9 based on any one of Configurations 1 to 8 above, the controller may have a shape holdable by a user with one hand.

When the controller is held and operated with one hand, since the user grips the controller, the user more easily feels the vibration of the controller. In this regard, when operating without gripping the controller, there is a possibility that the perception of the vibration of the controller is felt weaker due to the gap between a case where the controller is gripped and a case where the controller is not gripped. According to the above configuration example, it is possible to make such differences in perception depending on how the controller is held closer.

### Configuration 10

In Configuration 10 based on any one of Configurations 1 to 9 above, the controller may be a controller capable of mouse operation on the work surface.

According to this disclosure, appropriate vibration control corresponding to a mode of use of the controller can be performed.

### BRIEF DESCRIPTION OF THE DRAWINGS

FIG. 1 is a block diagram showing a non-limiting example of the hardware configuration of an information processing system 1;

FIG. 2 shows a non-limiting example of the appearance of a controller 4;

FIG. 3 shows a non-limiting example of an operation mode of the controller 4;

FIG. 4 shows a non-limiting example of the orientation of the controller 4;

FIG. 5 shows a non-limiting example of an operation mode of the controller 4;

FIG. 6 shows a non-limiting example of various data stored in a storage unit 22 of an information processing apparatus 2; and

FIG. 7 is a flowchart showing the details of game processing.

### DETAILED DESCRIPTION OF NON-LIMITING EXAMPLE EMBODIMENTS

Hereinafter, an exemplary embodiment will be described.

### Hardware Configuration of Information Processing Apparatus 2

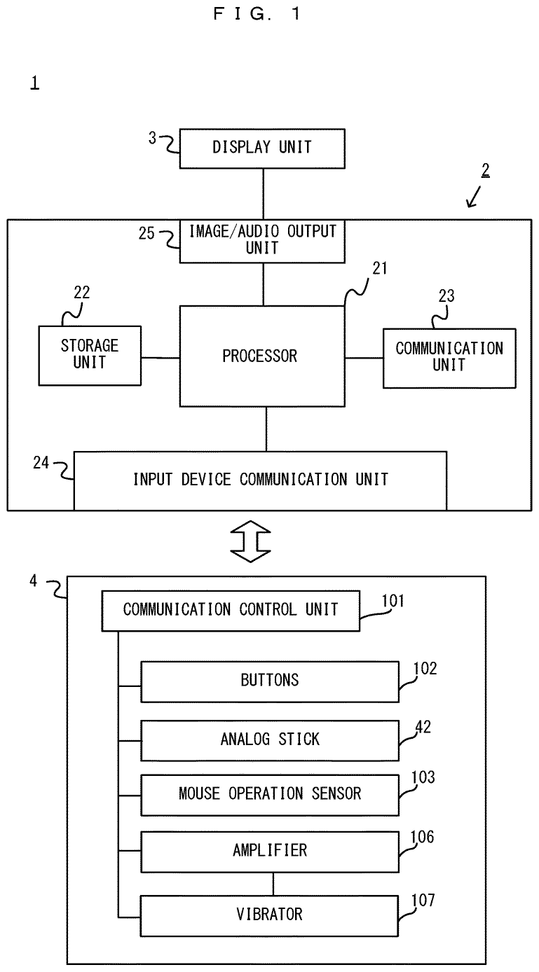

FIG. 1 is a block diagram showing an example of the hardware configuration of an information processing system 1 according to the exemplary embodiment. In FIG. 1, the information processing system 1 includes an information processing apparatus 2, a display unit 3, and a controller 4. The information processing apparatus 2 includes a processor 21. The processor 21 is an information processing unit that executes various types of information processing executed in the information processing apparatus 2. In the exemplary embodiment, the processor 21 is composed of an SoC (System-on-a-chip) including at least a CPU (Central Processing Unit) function and a GPU (Graphics Processing Unit) function. In another embodiment, the CPU and the GPU may be separate components. The processor 21 executes various types of information processing by executing an information processing program stored in a storage unit 22. The storage unit 22 may be an internal storage medium such as a flash memory or a DRAM (Dynamic Random Access Memory) or may be configured to utilize an external storage medium mounted to a slot that is not shown, or the like. Note that the information processing apparatus may be, for example, a game apparatus, or may be a personal computer or a server.

In addition, the information processing apparatus 2 includes a communication unit 23 for performing communication with another information processing apparatus or a specified server.

In addition, the information processing apparatus 2 includes an input device communication unit 24 for the information processing apparatus 2 to perform wired or wireless communication with various input devices. In the exemplary embodiment, an example in which the controller 4 is used as an example of an input device will be described.

In addition, the display unit 3 (for example, a monitor, etc.) is connected to the information processing apparatus 2 via an image/audio output unit 25. The processor 21 outputs, for example, an image or audio generated by execution of the above information processing, to the display unit 3 via the image/audio output unit 25.

Next, the controller 4 will be described. First, an example of the appearance and a mode of use of the controller 4 assumed in the exemplary embodiment will be described.

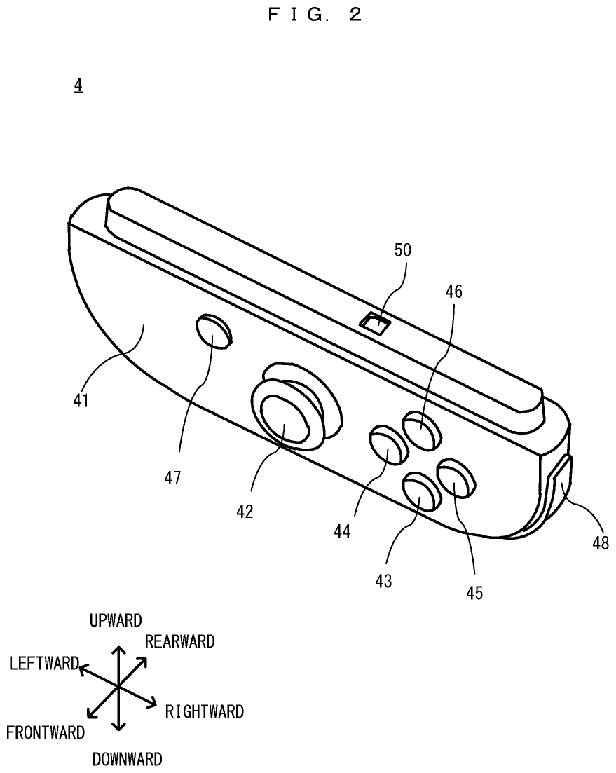

FIG. 2 shows an example of the appearance of the controller 4. In the example of FIG. 2, the controller 4 includes a substantially plate-shaped housing 41. In the exemplary embodiment, a main surface of the housing 41 (the surface on the front side in the front-rear direction shown in FIG. 2) is generally rectangular in shape. Further, in the exemplary embodiment, the housing 41 has a shape that is long in the left-right direction shown in FIG. 2. Further, as for the main surface of the housing 41, a lower corner portion in FIG. 2 has a shape more rounded than an upper corner portion.

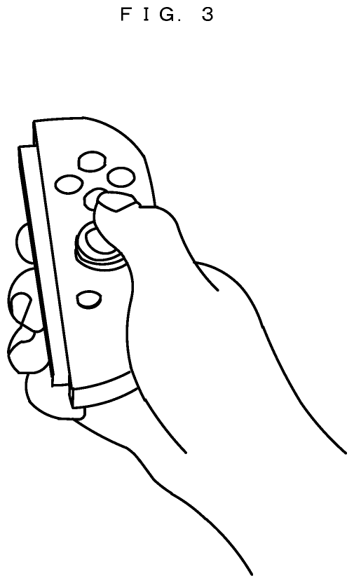

As shown in FIG. 3, the controller 4 can be held in an orientation in which the controller 4 is vertically long. Further, although not shown, the controller 4 can also be held in an orientation in which the controller 4 is horizontally long. When the controller 4 is held in a horizontal orientation, the controller 4 may be held by both hands of the user with the upward direction shown in FIG. 2 facing upward, the right side being held with the right hand, and the left side being held with the left hand.

The shape of the housing 41 is arbitrary, and in another embodiment, the housing 41 does not have to have a substantially plate shape. Further, the housing 41 does not have to be rectangular in shape, and may have, for example, a semicircular shape, or the like. Further, the housing 41 does not have to be vertically long in shape.

In FIG. 2, the controller 4 includes an analog stick 42 as a directional input portion. Further, the controller 4 includes four operation buttons 43 to 46 (specifically, an A-button 43, a B-button 44, an X-button 45, and a Y-button 46). Furthermore, the controller 4 includes a home button 47. As shown in FIG. 2, the analog stick 42, the respective operation buttons 43 to 46, and the home button 47 are provided on the main surface of the housing 41.

Further, the controller 4 includes an R-button 48. In the example of FIG. 2, the R-button 48 is provided on a lower right portion of a side surface of the housing 41. In the exemplary embodiment, since the lower right portion of the housing 41 has a rounded shape, the R-button 48 has a rounded shape according to the roundness of the lower right portion of the housing 41. The number and positions of the operation buttons provided in the controller 4 are arbitrary. For example, an operation button used particularly when the controller 4 is held in a horizontal orientation may also be provided on the upper side surface of the controller 4. Further, for example, another operation button may be further provided on the main surface of the controller 4.

Further, as shown in FIG. 2, a mouse sensor opening 50 is provided in the upper side surface of the controller 4. The controller 4 has a mouse operation sensor 103. The mouse operation sensor 103 is disposed on the inner side of the mouse sensor opening 50. The mouse operation sensor 103 is, for example, an optical mouse sensor. Although not shown, the mouse operation sensor 103 has, for example, a light source and a light-receiving sensor. The controller 4 may include a lens for condensing light emitted from the light source and/or light guided to the light-receiving sensor.

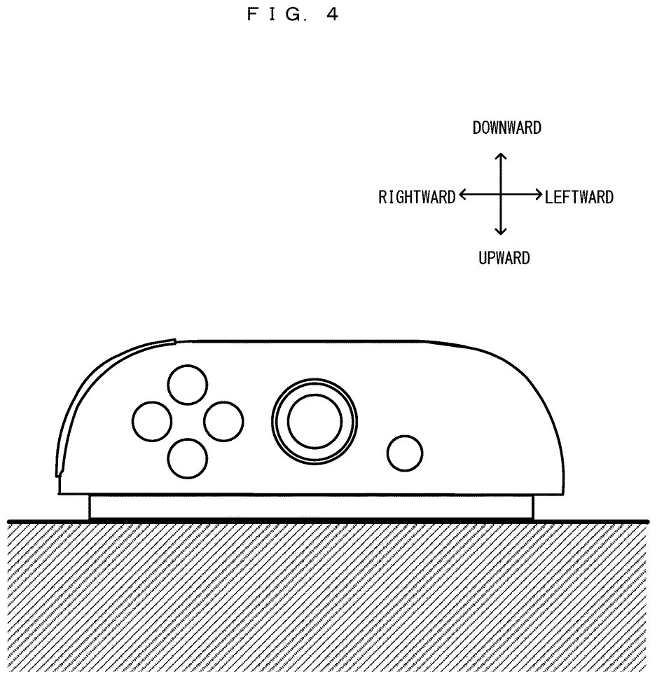

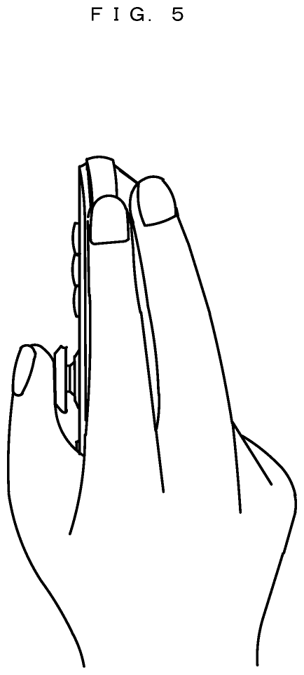

By providing the mouse operation sensor 103 as described above, the controller 4 can also be used as a mouse. When the controller 4 is placed on a work surface such that the surface in which the mouse sensor opening 50 is provided (the upper side surface in FIG. 2) faces the work surface, the mouse sensor opening 50 is at a position close to the work surface. Therefore, the mouse sensor opening 50 can effectively take in reflected light from the work surface. FIG. 4 shows an orientation when the controller 4 is used as a mouse. When the controller 4 is used as a mouse, at least a part of the upper side surface of the controller 4 is in contact with the work surface. FIG. 5 is a schematic diagram showing a state where the controller 4 is used as a mouse. As shown in FIG. 5, the palm of a hand of the user is placed so as to cover the lower side surface of the controller 4. The thumb of the right hand of the user is placed on the front side. For example, the thumb of the right hand of the user is put on the analog stick 42. The index finger of the right hand of the user is placed on the R-button 48.

Thus, the controller 4 of the exemplary embodiment can be operated in a plurality of states including a state where the controller 4 is mainly operated away from the work surface and a state where the controller 4 is mainly in contact with the work surface and is operated as a mouse as shown in FIG. 4 and FIG. 5 above, as in an operation mode in which the controller 4 is held and operated with one hand as shown in FIG. 3 above and an operation mode in which the controller 4 is held and operated with both hands. In the following description, a state where the controller 4 is in contact with the work surface and is operated as a mouse is referred to as a contact state. Further, a state where the controller 4 is operated away from the work surface is referred to as a separated state. For example, even when the controller 4 is being operated as a mouse, a separated state may occur when the user lifts the controller 4 to correct the position of the controller 4.

Referring back to FIG. 1, the hardware configuration of the controller 4 will be described. In FIG. 1, the controller 4 includes a communication control unit 101 that performs communication with the information processing apparatus 2. The communication control unit 101 is connected to each component as described later. In the exemplary embodiment, the communication control unit 101 can perform communication with the information processing apparatus 2 through both wired communication via a specified connection terminal (not shown) and wireless communication not via the connection terminal. For example, the controller 4 can be detachably attached to the information processing apparatus 2, and wired communication may be performed when the controller 4 is attached thereto. In this example, description will be given assuming a case where wireless communication is performed. That is, the communication control unit 101 performs wireless communication with the input device communication unit 24. Wireless communication between the input device communication unit 24 and the communication control unit 101 is performed according to, for example, the Bluetooth (registered trademark) standard.

Each button 102 (specifically, the above four operation buttons 43 to 46, the home button 47, and the R-button 48) and the analog stick 42 of the controller 4 repeatedly output information related to operations performed thereon to the communication control unit 101 at appropriate timings.

The mouse operation sensor 103 detects reflected light, from the contact surface, of the light emitted from the light source. The detection result of the mouse operation sensor 103 is repeatedly outputted to the communication control unit 101 at appropriate timings.

The communication control unit 101 acquires information related to input (specifically, information related to operation or a detection result by a sensor) from each input portion. The communication control unit 101 transmits operation data including the acquired information (or information obtained by performing specified processing on the acquired information) to the information processing apparatus 2. The operation data is repeatedly transmitted once per specified time. The intervals at which the information related to input is transmitted to the information processing apparatus 2 may be the same or may not necessarily be the same for each input portion.

By the operation data being transmitted to the information processing apparatus 2, the information processing apparatus 2 can know inputs performed on the controller 4. For example, the information processing apparatus 2 can know operations on each button 102 and the analog stick 42, based on the operation data. Further, based on the detection result of the mouse operation sensor 103, the information processing apparatus 2 can know movement parameters (for example, movement direction and movement distance) related to the movement of the controller 4 relative to the work surface.

Further, the information processing apparatus 2 of this example can determine whether the controller 4 is in contact, based on the operation data, in other words, whether the controller 4 is in the contact state or the separated state.

Further, the controller 4 includes a vibrator 107. In the exemplary embodiment, the vibrator 107 is controlled by an instruction from the information processing apparatus 2. That is, upon receiving the instruction from the information processing apparatus 2, the communication control unit 101 drives the vibrator 107 according to the instruction. Here, the controller 4 includes an amplifier 106. Upon receiving the instruction, the communication control unit 101 outputs a control signal corresponding to the instruction, to the amplifier 106. The amplifier 106 amplifies the control signal from the communication control unit 101, generates a drive signal for driving the vibrator 107, and provides the drive signal to the vibrator 107. Accordingly, the vibrator 107 operates. The vibrator 107 may be any type of actuator that generates vibration.

### Processing Assumed in Exemplary Embodiment

Next, an outline of information processing assumed in the exemplary embodiment will be described. In the exemplary embodiment, when a specified condition is satisfied in information processing such as game processing, the controller 4 is vibrated. An example of a scene in which the controller 4 is vibrated is a case where a specified condition is satisfied in game processing and an effect of explosion is executed in a game. Another example is a case where a player character is moved according to a specified operation performed by the user, in game processing. Further, an example of a scene other than game processing for vibrating the controller 4 is a case where, when news is received as a process of system software, the user is notified of the reception. And, in the exemplary embodiment, when vibrating the controller 4 since the specified condition for such vibration is satisfied, control is performed such that when the controller 4 is in the contact state, the controller 4 is vibrated more strongly than when the controller 4 is in the separated state. In this example, as an example of control for vibrating more strongly, an example of vibrating strongly by increasing the amplitude will be described. Here, when the controller 4 is in contact, vibration escapes to the work surface, so that it is conceivable that the user is less likely to feel vibration compared to a case where the controller 4 is separated from the work surface. That is, even if vibration of the same intensity is being outputted, when the controller 4 is placed on the work surface, there is a possibility that user's perception becomes weaker than when the controller 4 is lifted. From such a viewpoint, in the exemplary embodiment, control is performed such that when the specified condition for vibration is satisfied and the state of the controller 4 is the contact state, the controller 4 is vibrated more strongly than when the state is the separated state. Accordingly, perception of vibration when the specified condition is satisfied is made closer between a mouse operation state and a controller operation state.

Hereinafter, details of the processing according to the exemplary embodiment will be described. In the exemplary embodiment, for example, game processing in which the controller 4 is vibrated in the above explosion scene will be described as an example of the information processing.

### Example of Data to be Used

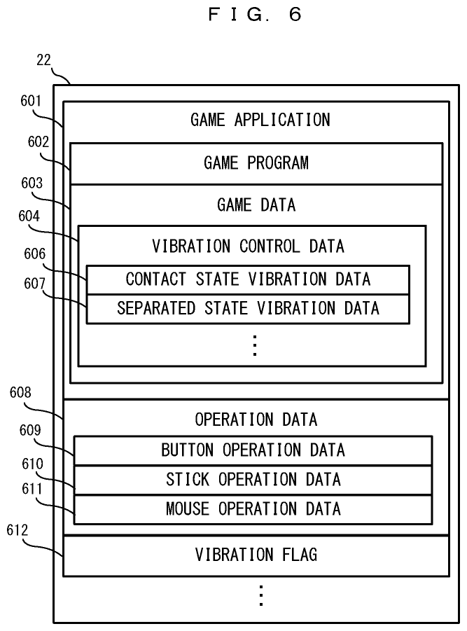

Next, various data to be used in the processing in the exemplary embodiment will be described. FIG. 6 is a memory map showing an example of various data stored in the storage unit 22 of the information processing apparatus 2. A game application 601, operation data 608, a vibration flag 612, etc., are stored in the storage unit 22.

The game application 601 includes a game program 602 and game data 603. The game program 602 is a program for executing the game processing according to the exemplary embodiment.

The game data 603 includes various data to be used in the game processing. In FIG. 6, the game data 603 includes vibration control data 604. The vibration control data 604 includes contact state vibration data 606 and separated state vibration data 607. The vibration control data in this example is data that defines vibration contents in an explosion scene in a game. For example, the vibration control data is loaded on condition that a player character has used a bomb according to a user operation or that a timing for an explosion scene to be played in an image reproduced during the game has come. The contact state vibration data 606 is data that defines vibration contents for vibrating the controller 4 when in the contact state. The separated state vibration data 607 is data that defines vibration contents for vibrating the controller 4 when in the separated state. Each data includes amplitude information and frequency information in a certain period as an example. In the exemplary embodiment, as for amplitude, as described above, it is set to be larger when in the contact state than when in the separated state. In another embodiment, for example, different vibration frequencies may be set for the contact state and the separated state. In this case, the frequency of vibration is also changed depending on the state of the controller 4. For example, the frequency in the contact state may be set to a higher frequency than that in the separated state, or may be set to a lower frequency than that in the separated state. By changing the frequency depending on the state of the controller 4 in this way, perceptions of vibration in both states may be made closer.

In this example, for convenience of description, an example in which there is only one piece of vibration control data 604 is shown, but a plurality of pieces of vibration control data 604 may be prepared depending on scenes in which the controller 4 is desired to be vibrated.

Further, although not shown, the game data 603 includes, for example, data of various objects appearing in the game and various image/audio data.

The operation data 608 is data for indicating operation contents performed on the controller 4. The operation data 608 includes button operation data 609, stick operation data 610, and mouse operation data 611. The button operation data 609 is data indicating the pressed states of the various buttons. The stick operation data 610 is data indicating an input direction, an input amount, etc., of the analog stick 42. The mouse operation data 611 is data indicating a detection result of the mouse operation sensor 103.

The vibration flag 612 is a flag for indicating whether or not control for vibrating the controller 4 (more accurately, the vibrator 107) (vibration control) is being performed. During vibration control, the vibration flag 612 is set to ON. Further, the vibration flag 612 is initially OFF.

### Example of Flowchart

Next, an example of a flowchart of the game processing will be described. In the exemplary embodiment, one or more processors read and execute a program stored in one or more memories, whereby a flowchart shown below is realized. In addition, the flowchart is merely one example of the processing procedure. Therefore, the processing order of steps may be changed as long as the same result is obtained. Further, values of variables and thresholds used in determination steps are also merely examples, and other values may be adopted as necessary.

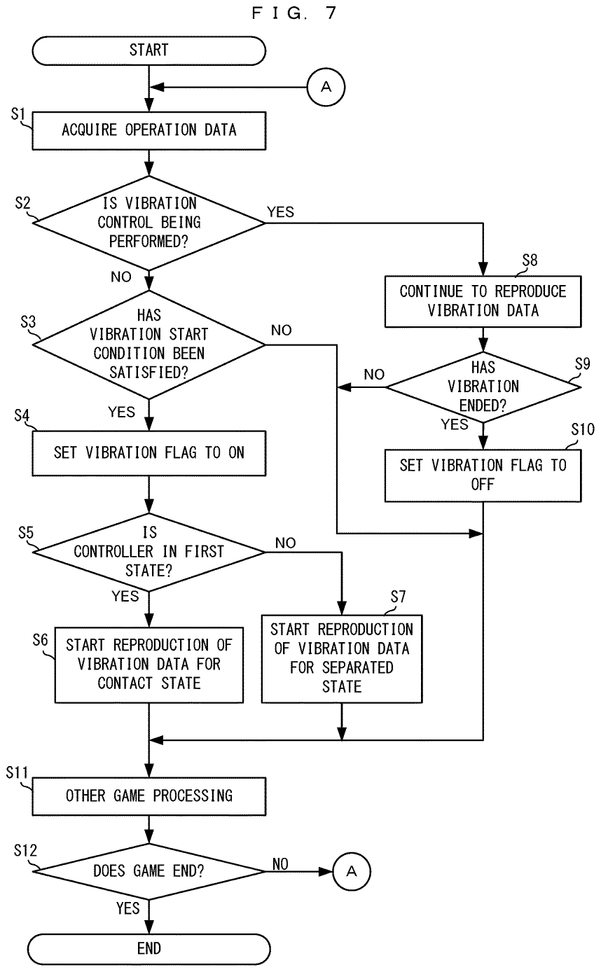

FIG. 7 is a flowchart showing the details of an example of the game processing according to the exemplary embodiment. A process loop of steps S1 to S12 of FIG. 7 is repeated a plurality of times per second according to the frame rate.

First, in step S1, the processor 21 acquires the operation data 608.

Next, in step S2, the processor 21 determines whether or not vibration control of the controller 4 is being performed, based on the vibration flag 612. Specifically, if vibration data defined by the contact state vibration data 606 or the separated state vibration data 607 is being reproduced, it is determined that vibration control is being performed. If, as a result of the determination, vibration control is not being performed (NO in step S2), then in step S3, the processor 21 determines whether or not a condition for starting vibration control of the controller 4 (vibration start condition) has been satisfied. If, as a result of the determination, the vibration start condition has not been satisfied (NO in step S3), the processing proceeds to step S11 described later. On the other hand, if the vibration start condition has been satisfied (YES in step S3), in step S4, the processor 21 sets the vibration flag 612 to ON.

Next, in step S5, the processor 21 determines whether or not the controller 4 is in the contact state or the separated state, based on the mouse operation data 611. That is, it is determined whether or not the controller 4 is in a state of being placed on the work surface in the orientation as shown in FIG. 4. Any determination method may be used, but for example, based on the mouse operation data 611, if the reflected light is detected, the state is determined to be the contact state, and if not detected, the state is determined to be the separated state. Further, for example, the state may be determined to be the contact state by detecting that a change in a value related to reflected light has occurred, that is, the controller 4 is moving on the work surface.

If, as a result of the determination, it is determined that the controller 4 is in the contact state (YES in step S5), in step S6, the processor 21 starts reproduction of the vibration data defined by the contact state vibration data 606 corresponding to the satisfied vibration start condition. Then, the processing proceeds to step S11 described later.

On the other hand, if, as a result of the determination, it is determined that the controller 4 is not in the contact state, that is, is in the separated state (NO in step S5), in step S7, the processor 21 starts reproduction of the vibration data defined by the separated state vibration data 607 corresponding to the satisfied vibration start condition. Then, the processing proceeds to step S11 described later.

Here, as described above, the intensity of vibration for the contact state is preset so as to be higher than that for the separated state. Therefore, as a result of the control as described above, for example, even in the same explosion scene, the controller 4 is vibrated more strongly when the controller 4 is in the contact state than when the controller 4 is in the separated state.

Next, processing in a case where it is determined that vibration control is being performed (YES in step S2) as a result of the determination in step S2 will be described. In this case, first, in step S8, the processor 21 continues reproduction processing of vibration data. Next, in step S9, the processor 21 determines whether or not reproduction of the vibration data has ended. If, as a result of the determination, reproduction of the vibration data has ended (YES in step S9), in step S10, the processor 21 sets the vibration flag 612 to OFF. Then, the processing proceeds to step S11. On the other hand, if reproduction of the vibration data has not ended yet (NO in step S9), the process in step S10 is skipped.

By the control as described above, in the exemplary embodiment, when vibration control of the controller 4 is being performed, even if the state of the controller 4 changes, the processing continues vibration control with the intensity defined by the vibration data being reproduced. That is, if vibration control is started when the controller 4 is in the contact state, even if the state changes to the separated state during the vibration, the intensity of vibration remains at the level for the contact state and does not change. The same applies to the reverse case. By such control, it is possible to reduce the risk of giving the user a sense of discomfort due to the intensity of vibration changing during vibration of the controller 4.

Next, in step S11, the processor 21 executes other game processing, and outputs a game image or audio reflecting the execution result.

Next, in step S12, the processor 21 determines whether or not a condition for ending the game processing has been satisfied. If the condition has not been satisfied (NO in step S12), the processing returns to step S1 above and is repeated. If the condition has been satisfied (YES in step S12), the game processing ends.

Thus, in the exemplary embodiment, when the controller 4 is in the contact state in which the controller 4 is placed on the work surface and operated, control is performed so as to vibrate the controller 4 more strongly than in the separated state in which the controller 4 is operated away from the work surface. Thereby, perception of vibration when the specified condition is satisfied can be made closer between when the controller 4 is placed on the work surface and when the controller 4 is not.

### Modifications

In the above-described embodiment, a case where vibration data for vibrating the controller 4 is prepared in advance has been described as an example. In this regard, in another embodiment, the intensity of vibration in the contact state and the intensity of vibration in the separated state may be configured to be settable by the user.

In the above example embodiment, an example in which whether the controller 4 is in the contact state or the separated state is determined based on the mouse operation data 611 has been given. However, determination of contact or separation may be performed by another means. For example, determination of contact or separation may be performed by an acceleration sensor or a gyro sensor in a case where the controller 4 includes the sensor, or may be performed by an external camera or the like.

Regarding the vibration control data 604, the above-described example showed an example where the vibration control data 604 is prepared in advance as a part of a game application (a part of game data). As another example, a system of the information processing apparatus 2 may have vibration control data. For example, if a specified notification condition on the system is satisfied, vibration based on the vibration control data that the system has may be realized.

In the above embodiment, the game application includes contact state vibration data and separated state vibration data as vibration data corresponding to a certain vibration start condition, but for example, the game application may have only one piece of vibration data corresponding to a certain vibration start condition, and may change and output the vibration data (hereinafter, basic vibration data) depending on the state of the controller 4. For example, when the controller 4 is in the contact state, vibration control may be performed by increasing amplitude in the basic vibration data. Alternatively, when the controller 4 is in the separated state, vibration control may be performed by decreasing the amplitude in the basic vibration data. The basic vibration data may be vibration data for a case where the controller 4 is in the contact state or vibration data for a case where the controller 4 is in the separated state.

Further, as another example, the game application may output vibration data to the system side without depending on the state of the controller 4, and the system side may execute processing corresponding to the state of the controller 4. For example, the game program may be configured to output both the contact state vibration data 606 and the separated state vibration data 607 corresponding to the satisfied vibration start condition to the system side if the specified vibration start condition is satisfied. Then, the system side may perform vibration control using either one depending on the state of the controller 4. Alternatively, the game application may output the basic vibration data to the system side, and the system may change the basic vibration data according to the state of the controller 4.

Further, as another example, the game application or the system may be configured to generate vibration data every time in response to the vibration start condition. In this case, by taking into account the state of the controller 4 at that time, vibration data may be generated such that the intensity of vibration to be generated is different.

Further, in the above embodiment, an example in which the processor 21 performs determination as to whether the controller 4 is in the contact state or the separated state has been given. In this regard, in another embodiment, the controller 4 itself, instead of the processor 21, may be configured to be able to determine the state of the controller 4.

Further, the controller 4 itself may recognize the state of the controller 4, or may not necessarily recognize the state of the controller 4 itself. In the latter case, for example, the controller 4 may determine/store the state of the controller 4 in the information processing apparatus 2 by constantly sending a set of similar input signals to the information processing apparatus 2 without recognizing which state the controller 4 itself is in.

Further, the intensity of vibration when the controller 4 is in the contact state and/or when in the separated state may be settable by the user. For example, the user may be allowed to set to what degree each intensity of vibration when in the contact state and when in the separated state is made stronger or weaker relative to a reference intensity of vibration. Alternatively, the user may be allowed to set to what degree the intensity of vibration when in the contact state is made larger than when in the separated state.

Further, in the above embodiment and modifications, a mode in which the intensity of vibration is controlled depending on whether the controller 4 is in the contact state or the separated state has been illustrated. Besides this, for example, the intensity of vibration may be controlled depending on an operation state of the controller 4. For example, the intensity of vibration may be controlled depending on which of a state where the controller 4 is mainly separated from the ground and operated as a grip controller like a general game controller (hereinafter referred to as a “controller operation state”) and a state where the controller 4 is mainly operated as a mouse on the work surface as shown in FIG. 4 and FIG. 5 (hereinafter referred to as a “mouse operation state”), as in a operation mode in which the controller 4 is held and operated with one hand as shown in FIG. 3 or as in an operation mode in which the controller 4 is held and operated with both hands, the controller 4 is in. Specifically, when the controller 4 is in the mouse operation state, vibration may be made stronger than when the controller 4 is in the controller operation state. Since the controller 4 is mainly operated on the work surface in the mouse operation state, it can be said that the mouse operation state corresponds to a state of being operated on the work surface similarly to the contact state described above, and since the controller 4 is mainly lifted and operated in the controller operation state, it can be said that the controller operation state corresponds to a state of being operated away from the work surface similarly to the separated state described above. When the controller 4 is in the mouse operation state, in addition to the possibility that vibration escapes to the work surface as described above, since the controller 4 is not, for example, gripped and firmly held as in the controller operation state but is in a mode like putting a hand on the controller 4, there is a risk that the user's perception of vibration becomes further weaker. Therefore, by making vibration stronger in the mouse operation state than in the controller operation state, perception of similar vibration can be provided regardless of the state of use of the controller 4.

Between the mouse operation state and the controller operation state, processing executed for operations on the same input portion may be different. For example, processing in an application or a system executed when the R-button 48 is pressed may be different between the mouse operation state and the controller operation state. Alternatively, operations on some input portions may be ignored in some operation states. Alternatively, when an input portion for a direction operation such as the analog stick 42 is operated toward a certain direction, processing corresponding to an operation toward different directions may be executed between the mouse operation state and the controller operation state. As an example, interpretation of direction input may be different between the mouse operation state and the controller operation state.

A method for determining whether the operation state of the controller 4 is the mouse operation state or the controller operation state is not particularly limited. For example, the controller 4 may include a physical switch switchable by the user, and the processor 21 may determine which state the operation state is based on the state of the physical switch. Alternatively, the information processing apparatus 2 may perform a process of making the user specify the operation state of the controller 4 to be used at the time of startup or during startup. In the process, for example, the information processing apparatus 2 may determine that the controller 4 is in the contact state if a specified button of the controller 4 is pressed, and may determine that the controller 4 is in the separated state if another specified button is pressed. Alternatively, the operation state may be arbitrarily selectable by the user from a setting menu of the game application or system.

As the controller operation state, an operation state with one hand as in FIG. 3 and an operation state in which the controller 4 is held and operated with both hands may be set as different operation states. In this case, in any operation state, vibration may be made weaker than in the mouse operation state, or in at least one of the operation states, vibration may be made weaker than in the mouse operation state. There may be three or more different operation states as the controller operation state, and there may be another operation state in addition to or instead of the controller operation state and the mouse operation state.

Further, in the above embodiment, the controller 4 is capable of mouse operation, but may not necessarily be capable of mouse operation. For example, the controller 4 may be capable of being operated by being tilted while being in contact with the ground, or being operated by being pressed against the ground, instead of a mouse operation. Further, in the above embodiment, the controller 4 is capable of a controller operation of being lifted, but only a mouse operation may be possible on the controller 4. Even in the case where only a mouse operation is possible, button operations on the controller 4 separated from the ground may be possible.

Further, in another embodiment, in addition to the above-described change in intensity of vibration depending on the state of the controller 4 or instead of the change in intensity, other parameters related to vibration may be changed. For example, control that causes the user to have an illusion of a force sense of being pulled in one direction by vibration is assumed. In this case, parameters related to vibration may be changed such that a similar perception is obtained between when in the contact state and when in the separated state.

Further, in another embodiment, for example, control may be performed so as not to vibrate the controller 4 when in the contact state. Further, conversely, control may be performed so as not to vibrate the controller 4 when in the separated state.

Further, in the above embodiment, an example of control in which, when vibration of the controller 4 is started in the contact state, the intensity of vibration is not changed even if the state of the controller 4 changes to the separated state during control of the vibration, has been given. In this regard, in another embodiment, even during vibration, the intensity of vibration may be changed depending on the state of the controller 4. For example, if the state of the controller 4 changes to the separated state while the controller 4 is being vibrated based on vibration data for the contact state, switching to vibration control based on vibration data for the separated state may be performed according to the change in the state.

Further, in the above embodiment, a case where there is one controller 4 has been illustrated, but two or more controllers 4 may be used. In this case, similar processing may be executed for a specific or non-fixed controller 4 among the two or more controllers 4, or similar processing may be executed for all of the two or more controllers.

Further, in the above embodiment, a case where the above processing is executed by a single information processing apparatus 2 is described. The information processing apparatus 2 may include a plurality of storages and processors. Then, the above processing may be executed while being shared by these components. Further, the information processing apparatus may be a server, and the above processing may be executed in a distributed system consisting of a plurality of information processing apparatuses including the server.

While this disclosure has been described herein, it is to be understood that the above description is, in all aspects, merely an illustrative example, and is not intended to limit the scope thereof. It is to be understood that various modifications and variations can be made without deviating from the scope of this disclosure.

### INDUSTRIAL APPLICABILITY

The information processing system, the one or more non-transitory computer-readable storage medium, and the computer-implemented method according to this disclosure can provide information processing that appropriately vibrates a controller.

What is claimed is:

1. An information processing system comprising:
a controller including a vibrator and capable of user operations in a plurality of states including a first state where the controller is operated on a work surface and a second state where the controller is operated away from the work surface;
one or more processors; and
one or more memories storing instructions that cause the one or more processors to perform operations comprising: vibrating the vibrator when a specified condition is satisfied, wherein
the vibrating comprises vibrating the vibrator more strongly when an operation state of the controller is the first state than when the operation state is the second state.

2. The information processing system according to claim 1, wherein the vibrating comprises, during a period from after starting the vibration when the operation state of the controller is the first state until control related to the vibration ends, keeping intensity of the vibration even if the operation state of the controller changes from the first state to the second state.

3. The information processing system according to claim 1, wherein the vibrating comprises, during a period from after starting the vibration when the operation state of the controller is the second state until control related to the vibration ends, keeping intensity of the vibration even if the operation state of the controller changes from the second state to the first state.

4. The information processing system according to claim 1, wherein the vibrating comprises changing a frequency for vibrating the vibrator depending on whether the controller is in the first state or the second state.

5. The information processing system according to claim 1, wherein the operations further comprise allowing a user to set at least one of intensity of vibration of the vibrator in the first state and intensity of vibration of the vibrator in the second state.

6. The information processing system according to claim 1, wherein
the operations further comprise determining whether the controller is on the work surface, and
the first state is a state where the controller is determined to be on the work surface, and the second state is a state where the controller is determined not to be on the work surface.

7. The information processing system according to claim 1, wherein
the controller further comprises a physical switch configured to allow a user to perform a switching operation between two states, and
the first state is a state when a state of the switch is a third state, and the second state is a state when the state of the switch is a fourth state.

8. The information processing system according to claim 1, wherein the first state is a state where specified processing is executed for a specified operation on the controller, and the second state is a state where processing different from the specified processing is executed for the specified operation.

9. The information processing system according to claim 1, wherein the controller has a shape holdable by a user with one hand.

10. The information processing system according to claim 1, wherein the controller is a controller capable of mouse operation on the work surface.

11. One or more non-transitory computer-readable storage media having stored therein instructions that, when executed, cause one or more processors to perform operations comprising:
when a specified condition is satisfied, vibrating a vibrator included in a controller capable of user operations in a plurality of states including a first state where the controller is operated on a work surface and a second state where the controller is operated away from the work surface; and
when the specified condition is satisfied, vibrating the vibrator more strongly when an operation state of the controller is the first state than when the operation state is the second state.

12. The one or more non-transitory computer-readable storage media according to claim 11, wherein the operations further comprises, during a period from after starting the vibration when the operation state of the controller is the first state until control related to the vibration ends, keeping intensity of the vibration even if the operation state of the controller changes from the first state to the second state.

13. The one or more non-transitory computer-readable storage media according to claim 11, wherein the operations further comprises, during a period from after starting the vibration when the operation state of the controller is the second state until control related to the vibration ends, keeping intensity of the vibration even if the operation state of the controller changes from the second state to the first state.

14. The one or more non-transitory computer-readable storage media according to claim 11, wherein the operations further comprise changing a frequency for vibrating the vibrator depending on whether the controller is in the first state or the second state.

15. The one or more non-transitory computer-readable storage media according to claim 11, wherein the operations further comprise allowing a user to set at least one of intensity of vibration of the vibrator in the first state and intensity of vibration of the vibrator in the second state.

16. A computer-implemented method comprising:
when a specified condition is satisfied, vibrating a vibrator included in a controller capable of user operations in a plurality of states including a first state where the controller is operated on a work surface and a second state where the controller is operated away from the work surface; and
when the specified condition is satisfied, vibrating the vibrator more strongly when an operation state of the controller is the first state than when the operation state is the second state.

17. The computer-implemented method according to claim 16, further comprising, during a period from after starting the vibration when the operation state of the controller is the first state until control related to the vibration ends, keeping intensity of the vibration even if the operation state of the controller changes from the first state to the second state.

18. The computer-implemented method according to claim 16, further comprising, during a period from after starting the vibration when the operation state of the controller is the second state until control related to the vibration ends, keeping intensity of the vibration even if the operation state of the controller changes from the second state to the first state.

19. The computer-implemented method according to claim 16, further comprising changing a frequency for vibrating the vibrator depending on whether the controller is in the first state or the second state.

20. The computer-implemented method according to claim 16, further comprising allowing a user to set at least one of intensity of vibration of the vibrator in the first state and intensity of vibration of the vibrator in the second state.
